(19) United States
(12) Patent Application Publication
(10) Pub. No.: US 2018/0056702 A1
(43) Pub. Date: Mar. 1, 2018

(54) Security Device and Authentication Device

(71) Applicants: National University Corporation Kumamoto University, Kumamoto (JP); Zeon Corporation, Tokyo (JP)

(72) Inventors: Satoshi WATANABE, Kumamoto (JP); Kaiki TOKUMARU, Kumamoto (JP); Masashi KUNITAKE, Kumamoto (JP)

(21) Appl. No.: 15/674,222

(22) Filed: Aug. 10, 2017

(30) Foreign Application Priority Data
Aug. 17, 2016 (JP) 2016-160089

(51) Int. Cl. B42D 25/36; F21V 8/00; G01J 1/02; G01J 1/58

(52) U.S. Cl. CPC B42D 25/36; G02B 6/0003; B42D 25/29; G01J 1/58; G01J 1/0228

(57) ABSTRACT

A security device including a pair of transparent substrates having waveguides, wherein, in a waveguide of at least one of the pair of substrates there is disposed a luminescent material that emits light by simultaneously irradiating a first type light and a second type light having different wavelengths, and the first type light and the second type light are made incident on the respective waveguides in a state where the pair of substrates are overlapped with each other and the waveguides are in contact with each other, and thereby the contact part between the waveguides emits light.

### CROSS REFERENCE TO RELATED APPLICATION

The present invention relates to a security device and an authentication device. Priority is claimed on Japanese Patent Application No. 2016-160089, filed Aug. 17, 2016, the contents of which are incorporated herein by reference.

### BACKGROUND OF THE INVENTION

### Description of Related Art

The remarkable progress in the recent technology of integrating organic electroluminescent devices on a flexible plastic substrate makes it possible to fabricate a flexible display with high mechanical flexibility and transparency, and application thereof to electronic paper and transparent displays is fast approaching. Further, for example, Patent Document 1 discloses a structure in which an up-conversion material is compounded in a part of an optical device having a waveguide to thereby cause light emission by means of excitation light.

### Prior Art Documents

Patent Document 1: Japanese Unexamined Patent Application, First Publication No. H08-320422.

### SUMMARY OF THE INVENTION

### Problem to be Solved by the Invention

Amid such technological innovation, the demand for security devices related to transparent devices such as plastic banknotes and transparent mobile phones is increasing year by year. However, the conventional magnetic and the conventional security incorporated in an IC chip or the like have been seen as a problem as they cause the level of the transparency of the transparent device to decrease significantly.

The present invention takes the above circumstance into consideration, with an object of providing a security device applicable to a transparent device.

### Means for Solving the Problem

In order to solve the above problem, in a security device of the present invention there is provided a pair of transparent substrates having waveguides; in a waveguide of at least one of the pair of substrates, there is disposed a luminescent material that emits light by simultaneously irradiating a first type light and a second type light having different wavelengths; and the first type light and the second type light are made incident on the respective waveguides in a state where the pair of substrates are overlapped with each other and the waveguides are in contact with each other, and thereby the contact part between the waveguides emits light.

In the security device above, the substrate may have a transparent plate-shaped base material part having a recessed groove provided therein and a filling part that fills the recessed groove and that constitutes the waveguide, and the filling part may be composed of a transparent material having a refractive index higher than that of the base material part.

In the above security device, the luminescent material may be formed in a fine particle form while being compounded in the filling part and distributed to an opening side of the recessed groove.

In the above security device, the waveguide may have a branching part.

Further, an authentication device for authenticating the above security device comprises: a supporting part that supports a pair of the substrates aligned with each other in an overlapped state; a light source part that causes first type and second type lights to enter the waveguides of the pair of substrates; a detection part that detects a light emission pattern of the luminescent material; and an authentication part that performs security authentication based on the light emission pattern.

### Effect of the Invention

According to the present invention, it is possible to provide a security device applicable to a transparent device.

### BRIEF DESCRIPTION OF THE DRAWINGS

FIG. 1 is a perspective view showing a security device according to a first embodiment.

FIG. 2 is a perspective view showing an authentication device according to the first embodiment.

FIG. 3 is an energy level diagram of Er³⁺ions showing up-conversion luminescence.

FIG. 4 is a plan view of the security device according to the first embodiment.

FIGS. 5A-5D are diagrams showing a method for manufacturing a substrate of the first embodiment.

FIG. 6 is a plan view of a security device according to a second embodiment.

FIG. 7 is a plan view of a pair of substrates of a security device according to a third embodiment.

FIG. 8 is a plan view of the security device according to the third embodiment.

### DETAILED DESCRIPTION

Hereinafter, embodiments to which the present invention is applied will be described in detail with reference to the figures.

In the figures used in the following description, for the sake of emphasizing the characteristic portions, there are some cases where the characteristic portion is enlarged for the sake of convenience, and the dimensional ratio etc. of each constituent may not necessarily be the same as that in actual practice. Also, for the same purpose, some portions that are not characteristic may be omitted in the figures in some cases.

In each figure, the XYZ coordinate system is shown. In the following description, each direction will be explained as necessary, based on each coordinate system.

### First Embodiment

### Security Device

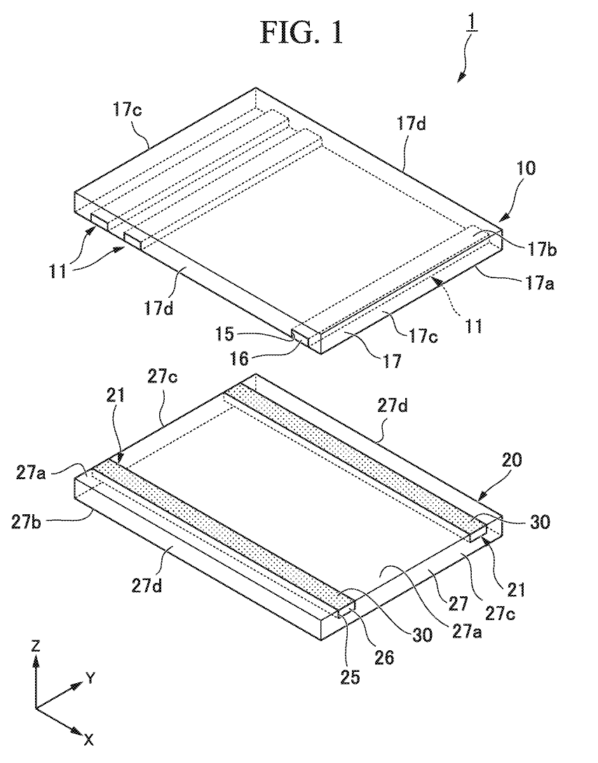

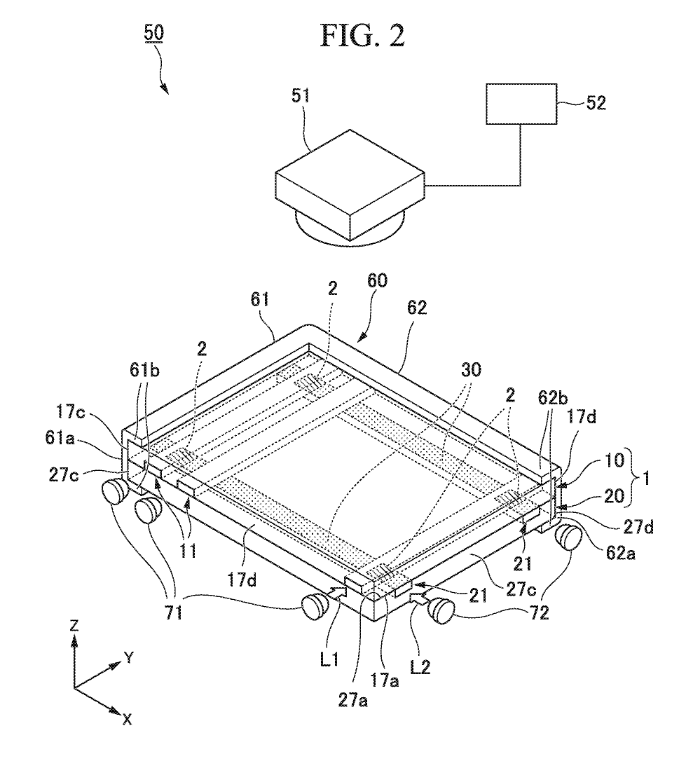

A security device 1 of a first embodiment is described. FIG. 1 is a perspective view showing the security device 1, and FIG. 2 is a perspective view showing an authentication device 50 for authenticating the security device 1.

As shown in FIG. 1, the security device 1 comprises a pair of transparent substrates (a first substrate 10 and a second substrate 20) having waveguides 11 and 21. The first substrate 10 and the second substrate 20 are stored separately like a Japanese tally, and while they are overlapped with each other, light is made incident to perform security authentication.

Hereinafter, each part will be specifically described.

### (Substrate)

The first substrate 10 has a transparent plate-shaped base material part 17 having recessed grooves 15 provided therein, and a filling part 16 that fills the recessed grooves 15. Similarly, the second substrate 20 has a transparent plate-shaped base material part 27 having recessed grooves 25 provided therein, and a filling part 26 that fills the recessed grooves 25. Moreover, in the filling part 16 of the first substrate 10, there is disposed a luminescent material 30.

### (Base Part)

The base material parts 17, 27 are made of a transparent material. The base material parts 17, 27 may be composed of a flexible resin material such as polydimethylsiloxane (PDMS), or may be composed of an inorganic material. The base material parts 17, 27 of the first and second substrates 10, 20 may also be composed of different materials.

The base material parts 17, 27 of the first and second substrates 10, 20 have the same plan-view rectangular shape.

The base material parts 17, 27 respectively have first surfaces 17a, 27a having recessed grooves 15, 16, and second surfaces 17b, 27b positioned on the opposite side thereof. In each figure, the first and second substrates 10, 20 are illustrated as having the first surfaces 17a, 27a facing each other.

Moreover, the base material parts 17, 27 have four side end surfaces. The four side end surfaces are classified into short edge end surfaces 17c, 27c each positioned on the short edge side of the rectangle, and long edge end surfaces 17d, 27d each positioned on the long edge side. As will be described later on the basis of FIG. 2, by aligning the short edge end surfaces 17c, 27c with the long edge end surfaces 17d, 27d without creating steps therebetween, the first and second substrates 10, 20 can be aligned.

The recessed grooves 15, 25 are respectively formed in the first surfaces 17a, 27a of the base material parts 17, 27. In the present embodiment, three recessed grooves 15 are formed in the base material part 17 of the first substrate 10, and two recessed grooves 25 are formed in the base material part 27 of the second substrate 20. It is preferable that the number of the recessed grooves 15, 25 and the position of each of the recessed grooves 15 are variously set for each individual security device 1.

The recessed grooves 15, 25 extend linearly. Also, the recessed grooves 15, 25 have a rectangular cross-sectional shape. The cross-sectional shape of the recessed grooves 15, 25 is not limited to a rectangular shape.

The recessed grooves 15 of the first substrate 10 extend so as to connect the long edge end surfaces 17d of the base material part 17.

The recessed grooves 15 open laterally at the long edge end surfaces 17d of the base material part 17. On the other hand, the recessed grooves 25 of the second substrate 20 extend so as to connect the short edge end surfaces 27c of the base material part 27. The recessed grooves 25 open laterally at the short edge end surfaces 27c of the base material part 27. The recessed grooves 15 and the recessed grooves 25 are orthogonal to each other. Moreover, as shown in FIG. 2, when the first and second substrates 10, 20 are overlapped with each other, the recessed grooves 15, 25 cross each other.

### (Filling Part, Waveguide)

The filling parts 16, 26 fill the recessed grooves 15, 25 respectively to constitute the waveguides 11, 21. Three waveguides 11 are provided on the first substrate 10 and two waveguides 21 on the second substrate 20 respectively, so as to correspond to the number of the recessed grooves 15, 25. The cross-sectional shape of the waveguides 11, 21 is rectangular as with the cross-sectional shape of the recessed grooves 15, 25. The widthwise dimension and the depthwise dimension of the waveguides 11, 21 are preferably 1 μm or more and 1 mm or less, respectively. By setting the widthwise dimension and the depthwise dimension of the waveguides 11, 21 to 1 μm or more, lights (the first type and second type lights L1, L2) of wavelengths applicable to the present invention can be propagated through the waveguides 11, 21 at an adequate level of efficiency. Furthermore, by setting the widthwise dimension and the depthwise dimension of the waveguides 11, 21 to 1 mm or less, the security device 1 can be miniaturized.

Lengthwise end parts of the waveguide (first waveguide) 11 of the first substrate 10 are respectively exposed at the pair of long edge end surfaces 17d of the base material part 17. Similarly, lengthwise end parts of the waveguide (second waveguide) 21 of the second substrate 20 are respectively exposed at the pair of short edge end surfaces 27c of the base material part 27. The exposed parts of the waveguides 11, 21 on the end surfaces of the base material parts 17, 27 serve as light entrance parts for receiving light. Although the waveguides 11, 21 of the present embodiment are respectively exposed at the end surfaces on both sides of the base material parts 17, 27, they may be exposed at least on one side.

In the second waveguide 21, the luminescent material 30 is arranged in layers in the opening side of the recessed groove 25. That is to say, in the filling part 26 of the second substrate 20, the luminescent material 30 is disposed in layers.

Also, it is sufficient that the luminescent material 30 is disposed in the waveguides of at least one of the first and second substrates 10, 20, and it may also be disposed in both of the waveguides 11, 21. Further, although the luminescent material 30 of the present embodiment is arranged in layers at the filling part 26, it may be dispersed inside the filling part 26 (or filling part 16). Note that the luminescent material 30 of this embodiment, which will be described later, has low luminous efficiency. Therefore, by arranging the luminescent material 30 in layers to thereby increase the density thereof, it is easy to ensure a sufficient amount of luminescence as the security device 1.

The filling parts 16, 26 are composed of a transparent material having a refractive index higher than that of the base material parts 17, 27, such as a high refractive polymer material. Here, the filling part 16 of the first substrate 10 has not only a refractive index higher than that of the base material part 17 of the first substrate 10, but also a refractive index higher than that of the base material part 27 of the second substrate 20. Similarly, the filling part 26 of the first substrate 20 has not only a refractive index higher than that of the base material part 27 of the second substrate 20, but also a refractive index higher than that of the base material part 17 of the first substrate 10. In the waveguides 11, 21, the filling parts 16, 26 function as cores through which light propagates, and the base material parts 17, 27 function as claddings. Therefore, the light that enters the waveguides 11, 21 repeats total reflection at the interface between the filling parts 16, 26 and the base material parts 17, 27 to propagate. As the high refractive polymer material usable for the filling parts 16, 26, for example, a cross-linked acrylic resin such as ethoxylated bisphenol A diacrylate or a cycloolefin polymer may be used.

As shown in FIG. 2, by having the first and second substrates 10, 20 overlapped while the first surfaces 17a, 27a are opposed to each other, the opening of the recessed groove 15 of the first substrate 10 is covered by the second substrate 20, and the opening of the recessed groove 25 of the second substrate 20 is covered by the first substrate 10. Therefore, in the first substrate 10, the filling part 16 is surrounded by the inner walls of the recessed groove 15 and the base material part 27 of the second substrate 20. Similarly, in the second substrate 20, the filling part 26 is surrounded by the inner walls of the recessed groove 25 and the base material part 27 of the second substrate 20. That is to say, by having the first and second substrates 10, 20 overlapped, it is possible to configure the core surrounded by the cladding on four sides to serve as the waveguides 11, 21, thereby improving light propagation efficiency.

When the first and second substrates 10, 20 are overlapped while the first surfaces 17a, 27a are opposed to each other, the waveguides 11, 21 come in contact with each other at a portion where the waveguides 11, 21 overlap in a plan view. In the portion where the waveguides 11, 21 are in contact with each other, light propagating in one of the waveguides enters the other waveguide.

The refractive index of the filling part 16 of the first substrate 10 is preferably lower than or equal to the refractive index of the filling part 26 of the second substrate 20 when the thicknesswise dimension of the layered region where the luminescent material 30 is disposed is not more than the wavelength of the excitation light (that is, the first type light or the second type light). The refractive index of the filling part 16 of the first substrate 10 is preferably equal to the refractive index of the filling part 26 of the second substrate 20 when the thickness of the luminescent material 30 is not less than the excitation light wavelength. As a result, it is possible to suppress total reflection of the light that has propagated through the first waveguide 11 at the interface of the contact part 2 with the second waveguide 21. That is to say, light can be efficiently made incident from the first waveguide 11 to the second waveguide 21, and light can be efficiently made incident on the luminescent material 30 in the second waveguide 21.

Note that in the case where the luminescent material 30 is disposed on both of the first and second waveguides 11, 21, it is preferable that the filling parts 16, 26 of the first and second substrates 10, 20 are composed of the same material so that the refractive indices of the waveguides 11, 21 are the same. Thereby, light can be efficiently made incident on each luminescent material 30 in the first and second waveguides 11, 21.

### (Luminescent Material)

The luminescent material 30 emits light when the first type light L1 and the second type light L2 having different wavelengths are simultaneously irradiated thereon. Examples of the luminescent material 30 include a two-frequency up-conversion luminescent material capable of converting near infrared light into visible light. Here, the up-conversion luminescence is a type of photoexcited luminescence that occurs when near-infrared light is irradiated on a rare-earth element such as Pr³⁺, Er³⁺, and Tm³⁺, in which a small amount of rare-earth element is doped in a low phonon oscillation material.

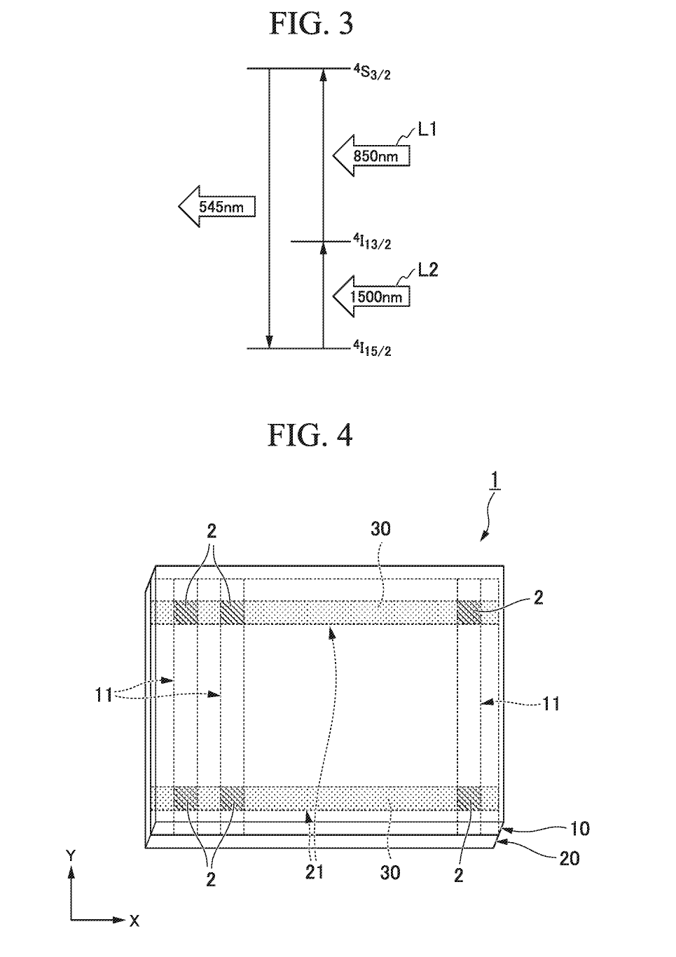

FIG. 3 is an energy level diagram of Er³⁺ ions showing up-conversion luminescence.

Er³⁺ ions emit green visible light having a wavelength of 545 nm when irradiated simultaneously with the first type light L1 having a near infrared wavelength of 850 nm and the second type light L2 having a near infrared wavelength of 1500 nm.

The up-conversion luminescent material serving as the luminescent material 30 of the present embodiment is formed of rare-earth element-containing ceramic nanoparticles. The rare-earth element-containing ceramic nanoparticles have a very long life and have luminescence characteristics that are not influenced by the external environment. Therefore damage to cryptographic information is also minimized. In addition, it is preferable that the refractive index of the rare-earth element-containing ceramics is adjusted to the same degree as the refractive index of the filling parts 16, 26. Thereby, light scattering due to the rare-earth element-containing ceramic nanoparticles can be suppressed, and transparency can be achieved.

Note that the luminescent material 30 does not need to be one that emits visible light by means of invisible light irradiation, and may be of a configuration that emits invisible light, for example, by means of two-frequency visible light irradiation.

The luminescent material 30 is formed in a fine particle form. The luminescent material 30 is compounded in the filling part 16 of the first substrate 10 and is distributed on the opening side of the recessed groove 15. Thereby, when the first and second substrates 10, 20 are overlapped with each other while the first surfaces 17a, 27a are opposed to each other, then in the first waveguide 11, the luminescent material 30 can be disposed on the interface side of the second waveguide 21. Therefore, the light that has propagated from the first and second waveguides 11, 21 is efficiently irradiated on the luminescent material 30.

In the present embodiment, the luminescent material 30 emits light by simultaneously irradiating the first type light L1 and the second type light L2 thereon. However, as the luminescent material 30, one which emits light by being excited by two lights of the same wavelength may be employed. In this case, light of the same wavelength can be used for the first type light L1 and the second type light L2.

### Authentication Device

The authentication device 50 is a device that performs security authentication by attaching the first and second substrates 10, 20.

As shown in FIG. 2, the authentication device 50 comprises a supporting part 60 that supports the first and second substrates 10, 20, a plurality of first and second light source parts 71, 72 that allow light to enter the first and second waveguides 11, 21, a detection part 51, and an authentication part 52.

### (Support Part)

The supporting part 60 supports the first and second substrates 10, 20 while having them overlapped and aligned. The supporting part 60 covers a pair of adjacent end surfaces of the overlapped first and second substrates 10, 20.

As shown in FIG. 2, the supporting part 60 has a first positioning part 61 and a second positioning part 62 that are disposed orthogonally to each other in plan view. The first positioning part 61 has a vertical plate part 61a that comes in contact with the short edge end surfaces 17c, 27c of the first and second substrates 10, 20, and a pair of lateral plate parts 61b that sandwich the first and second substrates 10, 20 from the plate thickness direction. Similarly, the second positioning part 62 has a vertical plate part 62a that comes in contact with the long edge end surfaces 17d, 27d of the first and second substrates 10, 20, and a pair of lateral plate parts 62b that sandwich the first and second substrates 10, 20 from the plate thickness direction.

The vertical plate parts 61a, 62a of the first and second positioning parts 61, 62 are plate members extending orthogonally to each other. The overlapped first and second substrates 10, 20 are positioned in the plane direction (that is, in the XY plane direction) by being brought into contact with the inner corner parts formed by the pair of vertical plate parts 61a, 62a.

The lateral plate parts 61b, 62b of the first and second positioning parts 61, 62 project in a direction orthogonal to the vertical plate parts 61a, 62a from the vertical direction edges (where the vertical direction is the Z axis direction, and is the thickness direction of the first and second substrates 10, 20) of the vertical plate parts 61a, 62a, which are orthogonal to each other. The distance between the pair of lateral plate parts 61b and the distance between the pair of lateral plate parts 62b are substantially equal to the total plate thickness of the first and second substrates 10, 20. Therefore, by sandwiching the first and second substrates 10, 20 while they are overlapped, the pair of lateral plate parts 61b and the pair of lateral plate parts 62b hold the first and second substrates 10, 20 from the thickness direction (from the Z axis direction) and can suppress positional deviation. Note that the distance between the pair of lateral plate parts 61b and the distance between the pair of lateral plate parts 62b may be variable. In this case, the pair of lateral plate parts 61b and the pair of lateral plate parts 62b can be brought close to each other to clamp the first and second substrates 10, 20.

### (Light Source Part)

The first light source part 71 is a light source that emits the first type light L1. The number of the first light source parts 71 is the same as that of the first waveguides 11 (three in the present embodiment). The first light source part 71 irradiates the first type light toward the end part of the first waveguide 11 exposed on the one long edge end surface 17d of the first substrate 10, causing the first type light L1 to enter the first waveguide 11.

The second light source part 72 is a light source that emits the second type light L2. The number of the second light source parts 72 is the same as that of the second waveguides 21 (two in the present embodiment). The second light source part 72 irradiates the second type light L2 toward the end part of the second waveguide 21 exposed on the one short edge end surface 27c of the second substrate 20, causing the second type light L2 to enter the second waveguide 21.

In the present embodiment, there is shown an example of the case where the same number of the first light source parts 71 as the first waveguides 11 are provided, and the same number of the second light source parts 72 as the second waveguide 21 are provided. However, light irradiated from each of a single first light source part 71 and a single second light source part 72 may be incident on the plurality of first waveguides 11 and the plurality of second waveguides 21.

In the present embodiment, the first light source part 71 is arranged so as to face one long edge end surface 17d among the pair of long edge end surfaces 17d of the first substrate 10, that is not covered by the supporting part 60. Moreover, the second light source part 72 is arranged so as to face one short edge end surface 27c among the pair of short edge end surfaces 27c of the second substrate 20, that is not covered by the supporting part 60. In this manner, it is preferable that the first and second light source parts 71, 72 are disposed on different edge surfaces of the first and second substrates 10, 20. Thereby, it is possible to achieve a configuration in which the first type light L1 irradiated from the first light source part 71 enters only the first waveguide 11 and does not enter the second waveguide 21. Similarly, it is possible to achieve a configuration in which the second type light L2 irradiated from the second light source part 72 enters only the second waveguide 21 and does not enter the first waveguide 11.

### (Detection Part)

The detection part 51 detects light emission patterns of the luminescent material 30 that emits light within the security device 1. As the detection part 51, a camera that incorporates a CCD image sensor may be used. The detection part 51 images the security device 1 from the normal direction of the mutually contacting surfaces (that is, the first surfaces 17a and 27a) of the first and second substrates 10, 20.

The detection part 51 may be configured to be able to detect light in the wavelength region of the light emitted by the luminescent material 30, but to not detect light in the wavelength regions of the first type and the second type lights L1, L2.

In the security device 1, there may be a case where light leakage of the first type and the second type lights L1, L2 may occur, depending on the precision and the surface property of each part. Since the detection part 51 does not detect the light in the wavelength ranges of the first type and the second type lights L1, L2, it is possible to suppress influence of light leakage on detection results. When the first type and the second type lights L1, L2 are non-visible light, a camera that detects only visible light can be used as the detection part 51.

### (Authentication Part)

The authentication part 52 performs security authentication based on the light emission pattern detected by the detection part 51. The authentication part 52 has a database of preliminarily stored light emission patterns in the interior thereof. The authentication part 52 compares the light emission pattern which is the detection result in the detection part 51 against the light emission pattern in the database, and performs authentication. Furthermore, the authentication part 52 may have an image processing part therein. In this case, it is possible to perform a noise removal process for removing any noise in the detection part 51.

### Operational Effect

As shown in FIG. 2, the authentication device 50 is such that the first and second substrates 10, 20 are supported in a state where the first and second substrates 10, 20 are overlapped and the waveguides 11 and the waveguides 21 are in contact with each other. Further, the authentication device 50 causes the first type and the second type lights L1, L2 to enter the waveguides 11, 21, respectively. The first type light L1 propagates within the first waveguide 11 while repeating total reflection, and the second type light L2 propagates within the second waveguide 21 while repeating total reflection. The first type light L1 that propagates through the first waveguide 11 penetrates into the second waveguide 21 at the contact part 2 where the first and second waveguides 11, 21 come into contact with each other, and irradiates on the luminescent material 30. Moreover the second type light L2 that propagates through the second waveguide 21 is always irradiated as the second type light L2. Therefore, in the vicinity of the contact part 2 where the waveguides 11, 21 are in contact with each other, the first type and the second type light L1, L2 simultaneously irradiate on the luminescent material 30 and the luminescent material 30 emits light.

FIG. 4 is a plan view of the security device 1 in a state where the first and second substrates 10, 20 are overlapped on each other. As shown in FIG. 4, in the security device 1 of the present embodiment, six rectangular contact parts 2 are formed in which the first and second waveguides 11, 21 overlap on each other in plan view and are in contact with each other. These contact parts 2 emit light by letting the first type and the second type light L1, L2 enter the first and second waveguides 11 and 21, thereby forming a light emission pattern on the plane. The light emission pattern, which is determined by the number, shape, and arrangement of the contact parts 2, can be formed in an infinite combination depending on the shape and arrangement of the waveguides 11, 21. In addition, the light emission pattern is uniquely determined by the configuration of the waveguides 11, 21 of the first and second substrates 10, 20.

The security device 1 of the present embodiment can perform security authentication by means of the light emission pattern that is expressed as a result of overlapping the first and second substrates 10, 20 and irradiating light thereon. Therefore, according to the present embodiment, it is possible to provide a Japanese tally-type security device 1 that enables authentication by separately storing and combining the first and second substrates 10, 20.

In addition, the first and second substrates 10, 20 are transparent. Therefore, the security device 1 can be employed for various transparent devices such as transparent communication devices (such as mobile phones), which are being developed in recent years.

Further, the base material parts 17, 27 and the filling parts 16, 26 of the present embodiment can be composed of flexible resin materials. In this case, the security device 1 can be mounted on a flexible device.

The security device 1 of the present embodiment has a luminescent material 30 that emits light when the first type and the second type lights L1, L2 are simultaneously irradiated thereon. Therefore, only the portion where the first type light and the second type light L1, L2 simultaneously enter emits light. As a result, in the security device 1, luminescence in response to light leakage or the like is unlikely to occur, and a high-resolution emission pattern can be realized. In particular, when the wavelengths of the first type and the second type light L1, L2 are different from each other, luminescence caused by light leakage can be more effectively suppressed.

Furthermore, according to the security device 1 of the present embodiment, both the first and second substrates 10, 20 are composed of the transparent base material parts 17, 27 and the filling parts 16, 26, both of which have flat plate shapes on both sides. Therefore, it is not possible to obtain information for duplicating the first and second substrates 10, 20 based on shape and visual information. That is to say, according to the present embodiment, it is possible to provide the security device 1 that makes duplication thereof very difficult.

Moreover, as a modified example of the present embodiment, a security device may be configured using three or more substrates. In this case, waveguides are respectively formed on the upper and lower surfaces of the substrate that is disposed in the middle stage when overlapped on each other. As a result, it is possible to realize a more complex light emission pattern and to provide a security device with increased security by increasing the number of tally components.

Further, another modified example of the present embodiment may be a structure such that one or both of the first and second substrates 10, 20 are separated. With such a configuration, it is also possible to provide a security device with an increased number of tally components.

### Manufacturing Method

Next, a method of manufacturing the security device 1 of the present embodiment is described.

The first and second substrates 10, 20 that constitute the security device 1 can be manufactured in substantially the same process. Hereinafter, the manufacturing method is described, represented by the second substrate 20. Note that the first substrate 10 can be manufactured by omitting the step of disposing the luminescent material 30 in the manufacturing method of the second substrate 20.

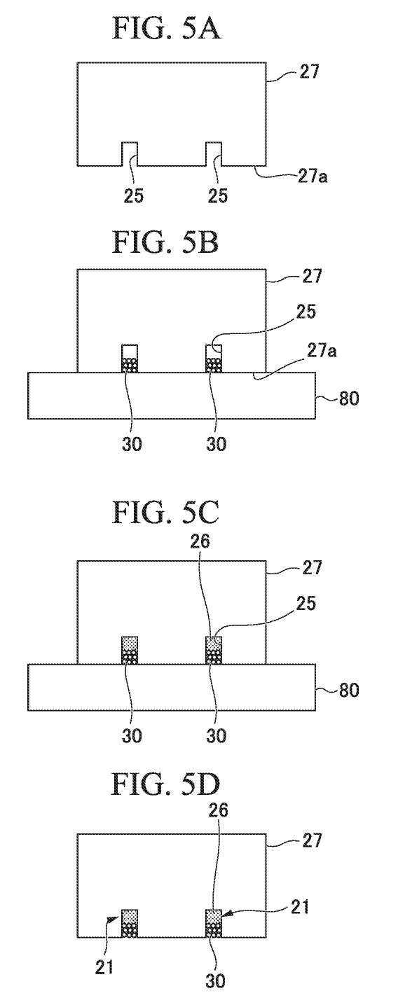

FIGS. 5A-5D are schematic diagrams showing each step of the method of manufacturing the second substrate 20, wherein FIG. 5A shows a step of preparing the base material part 27 having the recessed grooves 25 provided therein, FIG. 5B shows a step of disposing the luminescent material 30 on the opening side of the recessed grooves 25, FIG. 5C shows a step of forming the filling parts 26 by injecting and then allowing to cure the uncured resin material in the recessed grooves 25, and FIG. 5D shows the completed second substrate 20.

First, as shown in FIG. 5A, the base material part 27 having two recessed grooves 25 is prepared.

The base material part 27 can be formed by the following procedure, for example. First, for example, a mold having protrusions corresponding to the recessed grooves 25 is prepared. As the mold, one made of silicon or a resin material may be used. The mold has protrusions that are formed, for example, by means of optical lithography. By performing molding with use of this type of mold, the base material part 27 having the recessed grooves 25 can be manufactured.

Next, as shown in FIG. 5B, in a state where the first surface 27a side on which the recessed grooves 25 are formed is butted with a flat base member 80, the luminescent material 30 is arranged on the opening side of the recessed grooves 25. More specifically, first, the luminescent material 30 that has been formed in fine particle form is compounded with a volatile solvent (for example, ethanol) and sufficiently dispersed, and then, it is injected into the recessed grooves 25 using capillary action. Then by volatilizing the solvent, the luminescent material 30 can be disposed on the opening side of the recessed grooves 25.

Next, as shown in FIG. 5C, uncured resin material is injected into the recessed grooves 25 by utilizing capillary action, and it is then allowed to harden to form the filling parts 26.

Next, as shown in FIG. 5D, the base member 80 is removed.

Through the above steps, the second substrate 20 having the second waveguides 21 can be manufactured.

According to the method of manufacturing the security device 1 of the present embodiment, the filling parts 26 (that is, the waveguides 21) are formed by means of a capillary micro-molding method, which utilizes capillary action. Therefore, the security device 1 can be manufactured in a short period of time at low environmental load and low cost, without requiring exposure equipment, an etching process, and so forth as required in the conventional optical lithography method.

### Second Embodiment

Next, a security device 101 of a second embodiment is described.

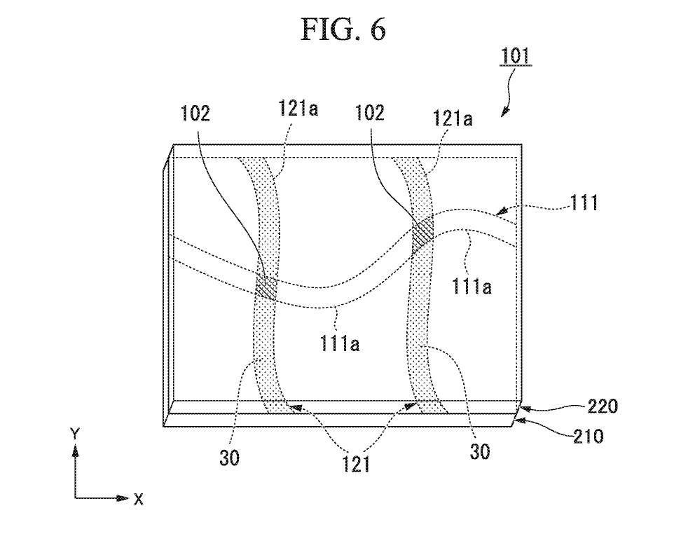

FIG. 6 is a plan view of the security device 101 in a state where the first and second substrates are overlapped on each other. The security device 101 differs from the first embodiment primarily in the configuration of waveguides 111, 121.

As with the first embodiment, the security device 101 has first and second substrates 110, 120. In addition, the first substrate 110 has one first waveguide 111, and the second substrate 120 has two second waveguides 121.

The first waveguide 111 has two curved parts 111a that are curved along the extending direction. The second waveguides 121 respectively have two curved parts 121a that are curved along the extending direction. Therefore, the first and second waveguides 111, 121 are each formed in an S shape along the extending direction.

Since the first and second waveguides 111, 121 have the curved parts 111a, 121a, contact parts 102 between the first and second waveguides 111, 121 do not necessarily line up linearly. Therefore, it is possible to make the light emission pattern formed by the arrangement of the contact parts 102 into a complex shape with fewer waveguides 111, 121. Thereby, it is possible to provide the security device 101 that makes duplication thereof even more difficult and that is highly secure.

### Third Embodiment

Next, a security device 201 of a third embodiment is described.

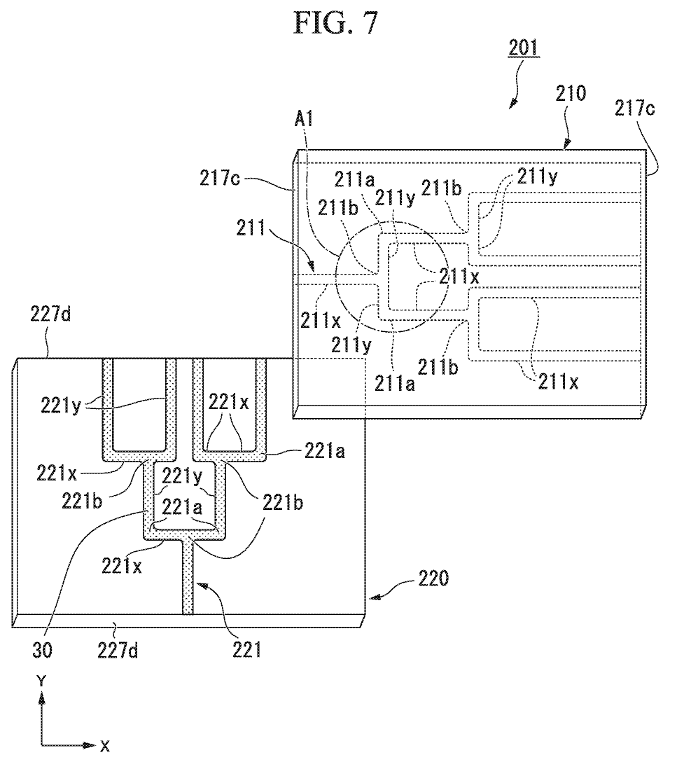

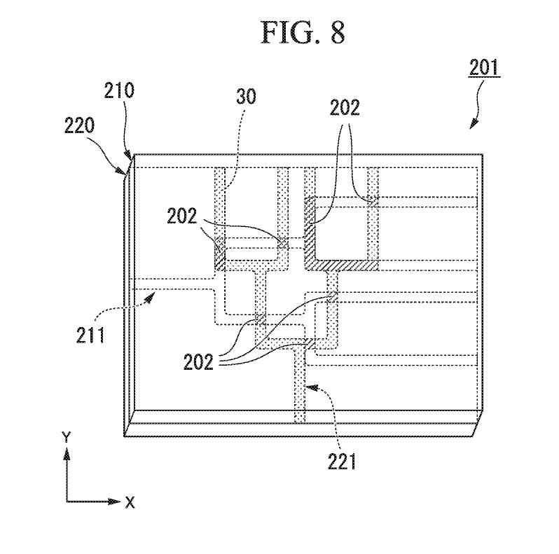

FIG. 7 is a plan view of a pair of substrates of the security device 201. Moreover, FIG. 8 is a plan view of the security device 201 in a state where the pair of substrates are overlapped on each other. The security device 201 differs from the first and second embodiments primarily in the configuration of waveguides 211, 221.

As with the first and second embodiments, the security device 201 has first and second substrates 210, 220. In addition, the first substrate 210 has a first waveguide 211, and the second substrate 220 has a second waveguide 221.

The first waveguide 211 has a plurality of branching parts 211b, a plurality of first linear parts 211x that extend in the X axis direction (a first direction), a plurality of second linear parts 211y that extend in the Y axis direction (a second direction not crossing over the first direction), and a plurality of curved parts 211a. In the present embodiment, the first linear parts 211x and the second linear parts 211y extend in mutually orthogonal directions.

In order to describe the shape of the first waveguide 211, attention is paid to a part region A1 (see FIG. 7) of the first waveguide 211. In the part region A1, the branching part 211b is positioned on one end of the first linear part 211x. In the branching part 211b, the first waveguide 211 branches into two second linear parts 211y. The curved part 211a is positioned at the end part of the second linear part 211y opposite to the branching part 211b. The curved part 211a is curved in a direction opposite to the direction in which the above first linear part 211x extends. Further, the curved part 211a is connected to a first linear part 211x that is different from the above first linear part 211x.

The first waveguide 211 has a shape in which the above part region A1 is repeated. As a result, the first waveguide 211 forms a shape like a tournament board.

The first waveguide 211 respectively opens at a pair of short edge end surfaces 217c of the first substrate 210 and extends so as to connect the pair of short edge end surfaces 217c to each other. The first waveguide 211 has one opening part at one short edge end surface 217c and four opening parts at the other short edge end surface 217c. The first waveguide 211 can form a complex optical path while branching the light at the branching parts 211b by disposing the light source part (not shown in the figure) on the side of the one short edge end surface 217c having one opening part.

The second waveguide 221 has a structure created by rotating the structure of the first waveguide 211 by 90°.

The second waveguide 221 has a plurality of branching parts 221b, a plurality of first linear parts 221y that extend in the Y axis direction (a second direction), a plurality of second linear parts 221x that extend in the X axis direction (the first direction not crossing over the second direction), and a plurality of curved parts 221a. In the present embodiment, the first linear part 211x and the second linear part 211y extend in mutually orthogonal directions.

The second waveguide 221 respectively opens at a pair of long edge end surfaces 227d of the second substrate 220 and extends so as to connect the pair of long edge end surface 227d to each other. The second waveguide 221 has one opening part at one long edge end surface 227d and four opening parts at the other long edge end surface 227d. The second waveguide 221 can form a complex optical path while branching the light at the branching parts 221b by disposing the light source part (not shown in the figure) on the side of the one long edge end surface 227d having one opening part.

As shown in FIG. 8, the first and second waveguides 211, 221 come in partial contact with each other to form the contact parts 202, by overlapping the first and second substrates 210, 220 on each other. Since the first and second waveguides 211, 221 are respectively branched at the branching parts 211b, 221b, the contact parts 202 are arranged within the plane in a complex manner. Therefore, according to the present embodiment, it is possible to make a light emission pattern that is formed by the arrangement of the contact parts 202 into a complicated shape. Thereby, it is possible to provide a security device 201 that makes duplication thereof even more difficult and that is highly secure.

Although the various embodiments of the present invention have been described above, the respective configurations and combinations thereof in the respective embodiments are merely examples, and additions, omissions, substitutions, and other modifications may be made to the configurations without departing from the scope of the invention. Furthermore, the present invention is not limited by the embodiments.

For example, in each of the embodiments described above, the first and second substrates have been described as having the same shape in plan view. However, the shapes in plan view of the first and second substrates need not necessarily be the same.

Although preferred examples of the present invention have been described above, the present invention is not limited to these examples. Additions, omissions, substitutions, and other modifications may be made to the configuration without departing from the scope of the invention. The present invention is not limited by the foregoing description, but only by the scope of the appended claims.

What is claimed is:

1. A security device comprising:
a pair of transparent substrates having waveguides, wherein:
in a waveguide of at least one of the pair of substrates, there is disposed a luminescent material that emits light by simultaneously irradiating a first type light and a second type light; and
the first type light and the second type light are made incident on the respective waveguides in a state where the pair of substrates are overlapped with each other and the waveguides are in contact with each other, and thereby the contact part between the waveguides emits light.

2. The security device according to claim 1, wherein the luminescent material emits light when the first type light and the second type light having different wavelengths are simultaneously irradiated thereon.

3. The security device according to claim 1, wherein:
the substrate comprises a transparent plate-shaped base material part having a recessed groove provided therein and a filling part that fills the recessed groove and that constitutes the waveguide; and
the filling part is composed of a transparent material having a refractive index higher than that of the base material part.

4. The security device according to claim 3, wherein the luminescent material is formed in a fine particle form while being compounded in the filling part and distributed to an opening side of the recessed groove.

5. The security device according to claim 1, wherein the waveguide has a branching part.

6. An authentication device that authenticates the security device according to claim 1, comprising:
a supporting part that supports a pair of the substrates aligned with each other in an overlapped state;
a light source part that causes first type and second type lights to enter the waveguides of the pair of substrates;
a detection part that detects a light emission pattern of the luminescent material; and
an authentication part that performs security authentication based on the light emission pattern.
